(19) United States
(12) Patent Application Publication
(10) Pub. No.: US 2024/0402820 A1
(43) Pub. Date: Dec. 5, 2024

(54) NON-CONTACT DETECTION AND RECOGNITION SYSTEM

(71) Applicant: SUNREX TECHNOLOGY CORP., Taichung City (TW)

(72) Inventor: Ying-Wei LIN, Taichung City (TW)

(21) Appl. No.: 18/363,364

(22) Filed: Aug. 1, 2023

(30) Foreign Application Priority Data
May 30, 2023 (TW) 112120156

(51) Int. Cl. G06F 3/01

(52) U.S. Cl. CPC G06F 3/017; G06V 2201/09

(57) ABSTRACT

A non-contact detection and recognition system is adapted to detect a gesture of an object, and includes a base, an optical detector and an optical notifier. The optical detector is disposed on the base, has a detection region, and is configured to detect the gesture of the object that appears in the detection region. The optical notifier is disposed in the base, and is configured to project notification light towards a place that corresponds in position to the detection region.

### CROSS-REFERENCE TO RELATED APPLICATION

This application claims priority to Taiwanese Patent Application No. 112120156, filed on May 30, 2023.

### FIELD

The disclosure relates to a recognition system, and more particularly to a non-contact detection and recognition system.

### BACKGROUND

A conventional gesture recognition system is applied in an electronic device, and includes a detection module and a recognition module. The detection module emits infrared rays to detect motion of a finger of a user. The recognition module is electrically connected to the detection module, and recognizes a gesture of the finger based on a result of the detection made by the detection module. Then, the electronic device can execute further operations based on a result of the recognition made by the recognition module.

However, when the user fails to place his/her finger properly, the motion of the finger of the user may be undetected by the detection module, resulting in unstable gesture recognition.

### SUMMARY

Therefore, an object of the disclosure is to provide a non-contact detection and recognition system that can alleviate the drawback of the prior art.

According to the disclosure, the non-contact detection and recognition system is adapted to detect a gesture of an object, and includes a base, an optical detector and an optical notifier. The optical detector is disposed on the base, has a detection region, and is configured to detect the gesture of the object that appears in the detection region. The optical notifier is disposed in the base, and is configured to project notification light towards a place that corresponds to the detection region in position.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating an embodiment of a non-contact detection and recognition system according to the disclosure disposed on a plane.

FIG. 2 is a block diagram illustrating an optical detector of the embodiment.

FIG. 3 is a schematic diagram similar to FIG. 1 and illustrating relative positions of a detection region and a notification area provided by the system of FIG. 1.

FIG. 4 is a schematic diagram similar to FIG. 3 and illustrating a scenario where a finger of a user appears in the detection region.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

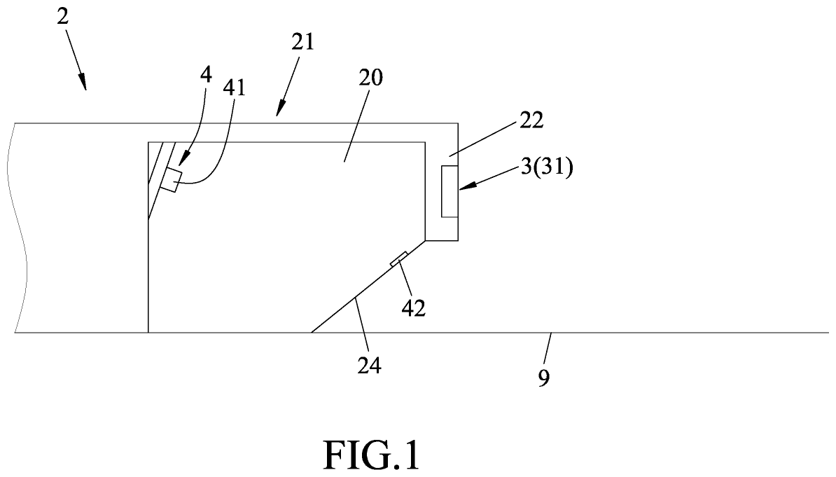

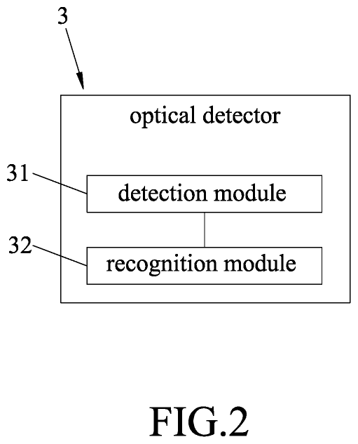

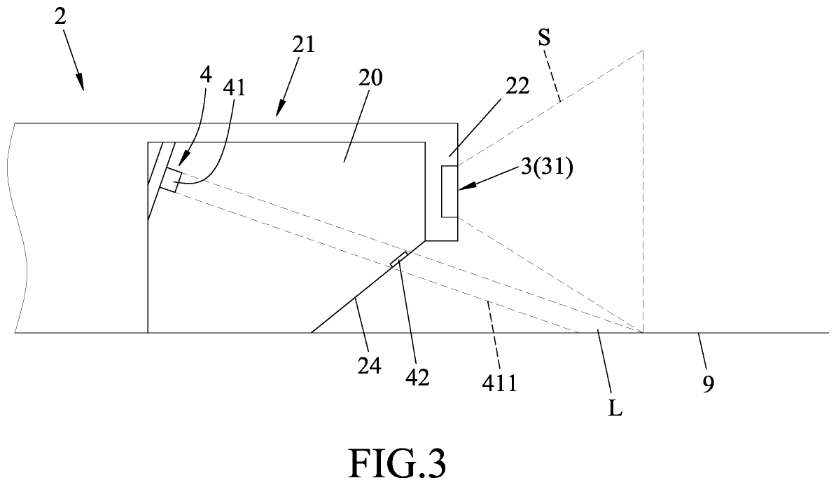

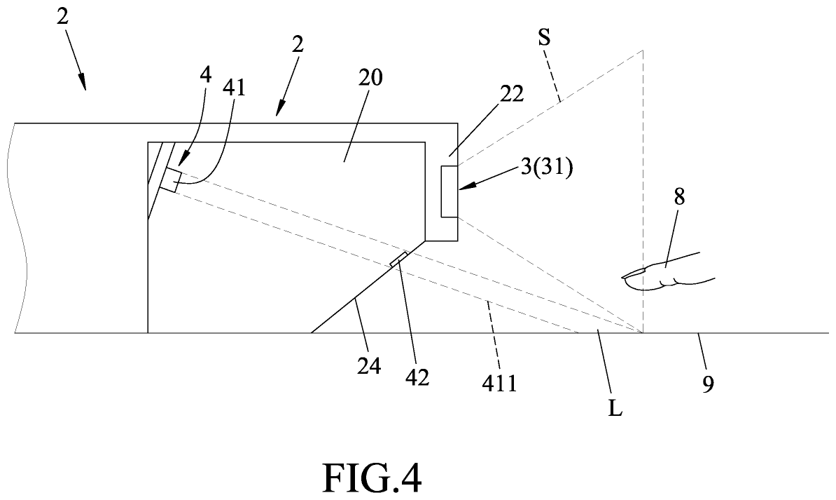

Referring to FIGS. 1 to 4, an embodiment of a non-contact detection and recognition system according to the disclosure is adapted to detect a gesture of an object (e.g., a finger 8 of a user shown in FIG. 4), and includes a base 2, an optical detector 3 and an optical notifier 4.

The base 2 includes a base portion 21 and an extension portion 22. The base portion 21 is adapted to be disposed on a plane 9. The extension portion 22 extends from the base portion 21. In this embodiment, the plane 9 is a surface of a desktop, and the base 2 is configured to be a component of a notebook computer. However, in other embodiments, the base 2 may be a component of a mouse, a component of a screen bracket, a component of a lamp, or a component of another gesture-based device which can be controlled to be turned on or off or to implement different operations by gestures. The disclosure is not limited in these respects.

The optical detector 3 is disposed on the extension portion 22 of the base 2. The optical detector 3 includes a detection module 31 and a recognition module 32. The detection module 31 faces away from the base portion 21 in a direction parallel to the plane 9, and is configured to detect motion of the object (e.g., the finger 8) that appears in a detection region (S), which is defined by a detectable range of the detection module 31. The recognition module 32 is electrically connected to the detection module 31, and is configured to generate gesture recognition information based on a result of the detection made by the detection module 31. In this embodiment, the detection region (S) is shaped like a truncated cone with a height in the direction that falls within a range from 4 cm to 5 cm, a semi-vertical angle (i.e., an angle between a generatrix line and an axis thereof) of 21°, and a base radius (i.e., a distance between a center of the detection module 31 and the plane 9) not greater than 3 cm, but the disclosure is not limited in these respects.

In this embodiment, the detection module 31 includes an infrared sensor. The infrared sensor emits infrared rays towards the detection region (S), determines whether there is an object (e.g., the finger 8) in the detection region (S) based on whether reflections of the emitted infrared rays are received, and, when it is determined that there is an object in the detection region (S), obtains motion of the object based on the received infrared rays. The recognition module 32 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a system on a chip (SoC), etc. The recognition module 32 determines the gesture based on the motion of the object, so as to generate the gesture recognition information. As such, the effect of gesture recognition is achieved. The gesture recognition information generated by the recognition module 32 can be transmitted to a controller (e.g., a central processing unit (CPU) of a notebook computer) (not shown) and can be further processed by the controller. In an example where the non-contact detection and recognition system of this embodiment is applied to a notebook computer, operations performed on a mouse by a user can be simulated by gestures of the finger 8. The technology of gesture recognition is known in the art and is not the main technical feature of the disclosure, so details thereof are omitted herein for the sake of brevity.

The optical notifier 4 is disposed on the base portion 21 of the base 2, and includes a light emitter 41 and a to-be-projected object 42. The light emitter 41 is disposed on the base portion 21, and is configured to project notification light 411 towards a place that corresponds in position to the detection region (S). The to-be-projected object 42 is disposed on the base portion 21 (specifically, a supporting wall 24 of the base portion 21), and is disposed in an optical path of the notification light 411. The light emitter 41 is configured to emit the notification light 411 to reach a notification area (L) that is on the plane 9 and that is directly below the detection region (S). In this embodiment, the to-be-projected object 42 allows transmission of light therethrough, and has a pattern (e.g., a brand logo), causing the notification light 411 to form an image of the pattern in the notification area (L). For instance, the to-be-projected object 42 may be a perforated plate with perforations that are arranged to form the pattern, or the to-be-projected object 42 may be a light-transmissive photographic slide of pattern.

In this embodiment, the base portion 21 is hollow and defines an inner space 20, and the light emitter 41 and the to-be-projected object 42 are disposed in the inner space 20, such that the notification light 411 can travel from the light emitter 41 to reach the to-be-projected object 42.

By designing the notification area (L) to be directly below the detection region (S), and by virtue of the light emitter 41 cooperating with the to-be-projected object 42 to project the notification light 411 forming the image of the pattern in the notification area (L), when using the non-contact detection and recognition system, the user can clearly see the notification area (L) and know where the detection region (S) is, and thus be able to put the finger 8 in the proper place and make a gesture, thereby ensuring stable gesture recognition.

In view of the above, the notification light 411 produced by the optical notifier 4 can notify the user of the position of the detection region (S), thereby facilitating the user to make a gesture in the detection region (S) of the optical detector 3 and ensuring stable gesture recognition by the optical detector 3.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A non-contact detection and recognition system adapted to detect a gesture of an object, comprising:
a base;
an optical detector disposed on said base, having a detection region, and configured to detect the gesture of the object that appears in the detection region; and
an optical notifier disposed on said base, and configured to project notification light towards a place that corresponds in position to the detection region.

2. The non-contact detection and recognition system as claimed in claim 1, wherein:
said base includes a base portion that is adapted to be disposed on a plane, and an extension portion that extends from said base portion;
said optical detector is disposed on said extension portion; and
said optical notifier is disposed on said base portion.

3. The non-contact detection and recognition system as claimed in claim 2, wherein:
the detection region extends in a direction parallel to the plane; and
said optical notifier includes a light emitter that is disposed on said based portion and that is configured to emit the notification light to reach a notification area on the plane directly below the detection region.

4. The non-contact detection and recognition system as claimed in claim 3, wherein said optical notifier further includes a to-be-projected object that is disposed on said base portion and in an optical path of the notification light, and that allows the notification light to pass therethrough.

5. The non-contact detection and recognition system as claimed in claim 4, wherein said to-be-projected object has a pattern, causing the notification light to form an image of the pattern in the notification area.

6. The non-contact detection and recognition system as claimed in claim 1, wherein said optical detector includes:
a detection module configured to detect motion of the object that appears in the detection region; and
a recognition module electrically connected to said detection module, and configured to generate gesture recognition information based on a result of the detection made by said detection module.
